(19) United States
(12) Patent Application Publication
(10) Pub. No.: US 2024/0245266 A1
(43) Pub. Date: Jul. 25, 2024

(54) Hand tool

(71) Applicant: Wow Gear, LLC, Santa Barbara, CA (US)

(72) Inventor: David Tognarelli, Santa Barbara, CA (US)

(73) Assignee: Wow Gear, LLC, Santa Barbara, CA (US)

(21) Appl. No.: 18/445,545

(22) Filed: Oct. 10, 2023

Related U.S. Application Data
(63) Continuation-in-part of application No. 29/885,886, filed on Mar. 2, 2023.
(60) Provisional application No. 63/440,398, filed on Jan. 21, 2023.

(51) Int. Cl. A47J 45/10; A01B 1/02; A47J 43/28; B25G 3/02

(52) U.S. Cl. CPC A47J 45/10; A01B 1/02; A47J 43/288; B25G 3/02

(57) ABSTRACT

A hand tool is disclosed which provides for extension and protection of a person's hand while allowing for the manipulation of a food product, even over a hot oven or grill. The hand tool comprises the tool section, a handle, and a shield sleeve. The handle can be attached to the tool section or to the shield sleeve. In one embodiment, the tool section is reversibly attached to the shield sleeve, so that the tool is interchangeable with other tools.

This application claims priority to US Design Application 29/885,886, filed Mar. 2, 2023 and U.S. Provisional Application No. 63/440,398, filed Jan. 21, 2023.

### FIELD OF THE DISCLOSURE

This disclosure teaches a handheld tool with an interchangeable tool attachment.

### BRIEF DESCRIPTION OF THE FIGURES

FIG. 1 is a front perspective view of a handheld food shredder;

FIG. 2 is an exploded view thereof;

FIG. 3 is a rear perspective view of a handle positioned in the food shredder tool;

FIG. 4 is rear perspective view of another embodiment of the handle positioned in a tool attachment of the handheld food shredder;

FIG. 5A is a rear view of yet another embodiment of the handle positioned in the tool attachment;

FIG. 5B is a rear perspective view of the embodiment of 5A;

FIG. 6 is a front elevation view of the handheld food shredder;

FIG. 7 is an overhead view thereof;

FIG. 8 is an overhead view showing a lengthened shield sleeve;

FIG. 9 is an exploded view of the handheld food shredder, showing an alternative feature not shown in FIG. 2;

FIG. 10 is a rear perspective view of the shield sleeve;

FIG. 11 is a bottom perspective view of the shield sleeve;

FIG. 12 is another embodiment of the tines;

FIG. 13 is another embodiment of the disclosure wherein the tool is a spoon;

FIG. 14 is another embodiment of the disclosure wherein the tool is a spatula;

FIG. 15 is another embodiment of the disclosure wherein the tool is a fork;

FIG. 16 is an embodiment as a yard tool; and

FIG. 17 is another embodiment of the yard tool.

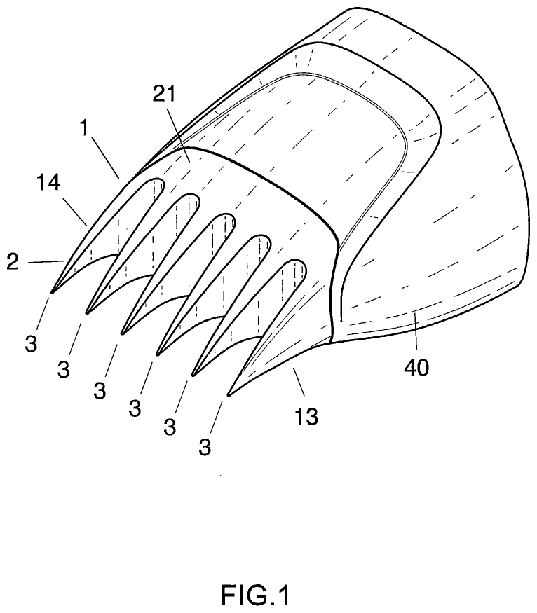

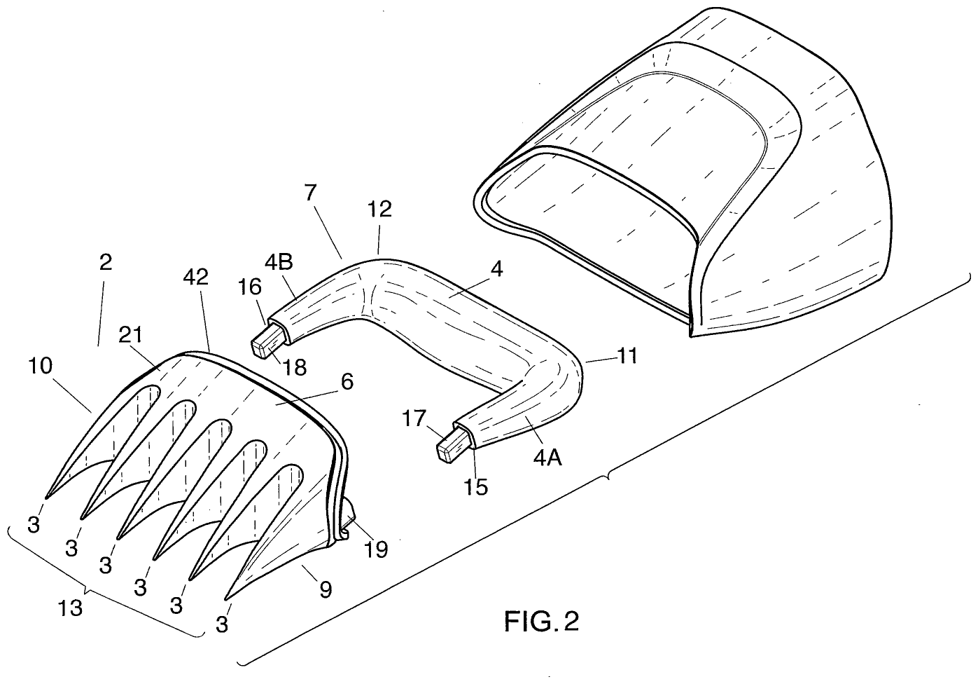

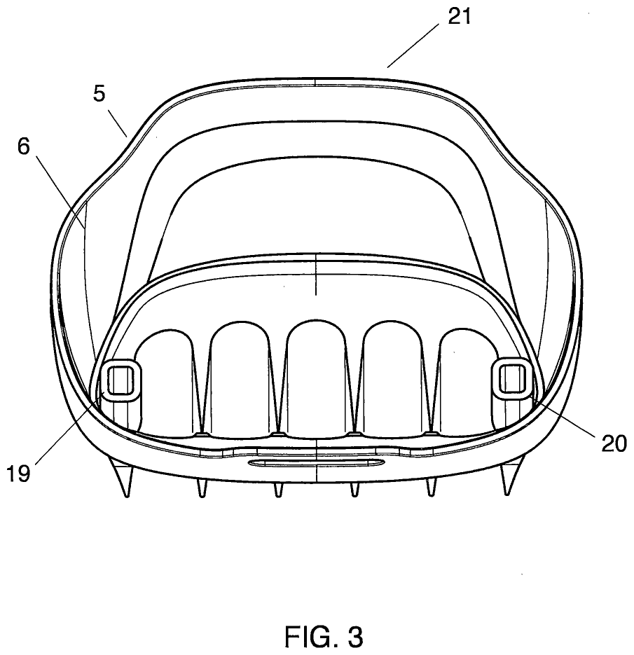

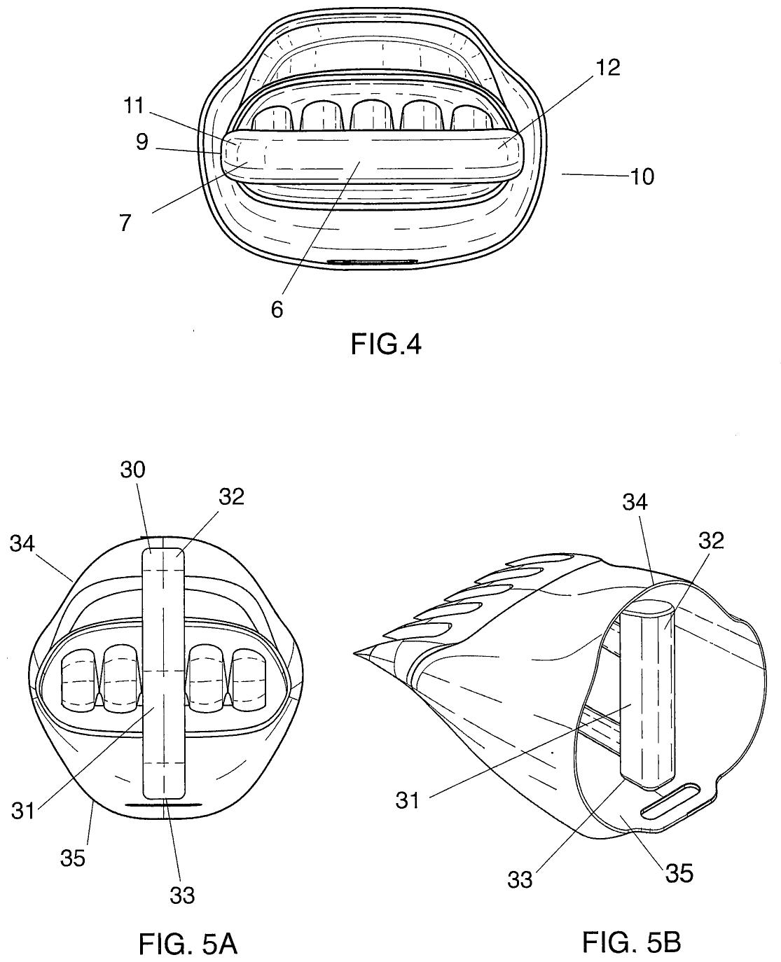

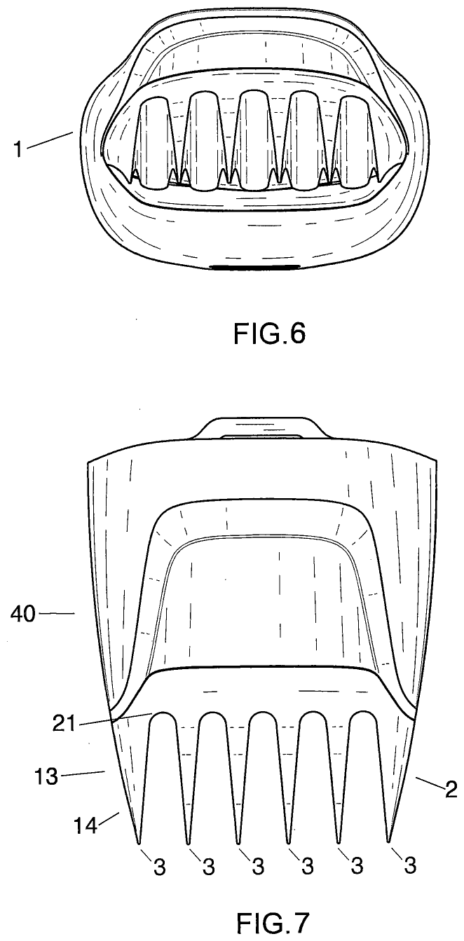

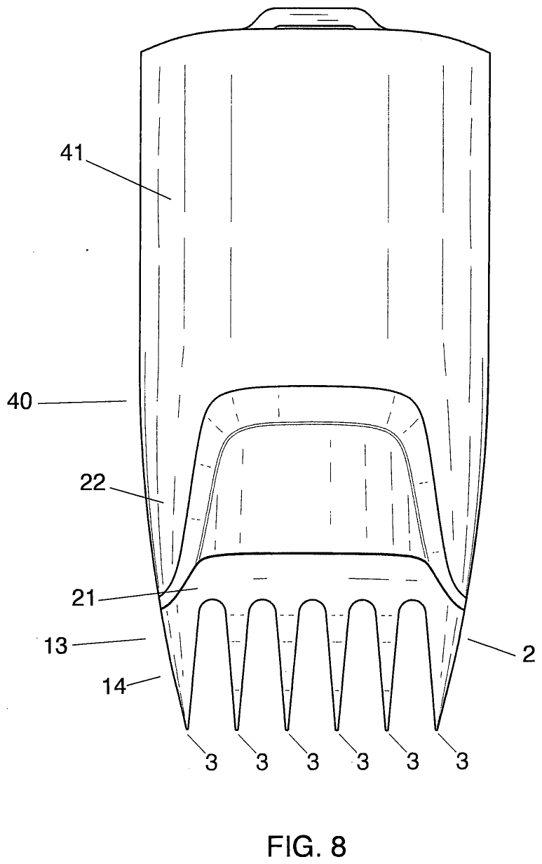

### DETAILED DESCRIPTION OF THE EMBODIMENT

The present disclosure 1 is a hand tool for shredding and handling and retaining rigid and semi-rigid meats and food products during food preparation and cooking in the kitchen and at the barbecue. The hand tool 1 used for these purposes has three principal sections. The first section is the tool attachment 13, in this case, the shredder attachment 2 for shredding, gripping, and retaining rigid and semi-rigid meats and food products during food preparation and cooking in the kitchen and over a barbecue, or smoker. The second part of the tool is a handle 7 for holding the tool 1, and the third part is a soft or rigid shield sleeve 40 made of heat resistant rubber, silicone, plastic materials, cloth, or combinations thereof. The purpose of the shield sleeve is to protect the hands from hot and greasy liquids and juices resulting from the handling of hot and cold food products. The handle 7 allows for the gripping and controlling of the claw or attached tool. The handle 7 is made out of heat resistant plastic, metal or even wood.

In one embodiment, the tool attachment contains a claw or shredder tool 2. The claw has the capability of gripping meats and other foods by skewering the meat and food with the integrated tined body to rigidly retain the meat and food product for food preparation and processing. The same claw can also be used for shredding meats, removing meats from ovens, BBQ grills, and smokers, cutting boards. The claw can also be used to toss salads, vegetables and meats in a bowl, platter or pan.

More specifically, tool attachment 13 is comprised of two basic sections, the working tool section 14 of the tool attachment 13 which is integral with the tool support section 21. The shredder tool 2 has a plurality of shredding blades or tines 3 extending from the proximal side of the tool support section 21. The working tool section 14 can be molded with the tool support section as one piece. Other means of non-reversible attachment known in art can also be used. Attachment can also be by any means, including friction between the two parts, screws, etc.

In one embodiment, the shredding blades 3 are made out of plastic. In another embodiment, the shredding blades 3 are made out of metal. In yet another embodiment, the blades 3 are comprised of a metal coating over plastic. In yet another embodiment, hollow metal blades are molded to fit snuggly over the plastic blades. In one more embodiment, the entire shredder attachment 2 is made of metal. In yet another embodiment, the entire shredder is made of heat resistant plastic. In one embodiment of the disclosure, there is a lipped edge 42 on the rear side 6 of the distal end of the tool support section 21.

In one embodiment, the second principal section, a handle 7, is attached inside of the tool support section 21, which is itself hollow. In this embodiment, a U-shaped handle 7 fits between side 9 and side 10, within tool support section 21, wherein the grip section 4 of the handle 7 is perpendicular to the length of the shredder tool 2. At each end 11, 12 of the grip section 4 are the legs 4a and 4b of the grip action. At terminus 15, 16 of each of the legs 4a, 4 b are spindles 17, 18, which fit securely and snugly within respectively shaped openings 19, 20 positioned within the rear side 6 of the distal end 5 of the tool support section 21. The handle 7 is by any means known in the art, including glue, screws, etc.

In another embodiment, handle 7 just comprises grip section 4, with the ends 11, 12 attached directly to inside walls 9, 10. Any method of attachment may be used to attach the ends of the handle may be used.

In an alternative embodiment, the handle 30 is positioned vertically. This handle 30, similar to the handle 7 supra, has a grip section 31, with each end 32, 33 respectively attached to an inner top side 34 and inner bottom side 35. Attachment means are well known to the art and the handle may or may not have legs.

It should be noted that in one embodiment, the shredder tool 2 is used in tandem with a second shredder tool 2 on the user's alternative or second hand. In one embodiment, the second shredder tool 2 is identical to the first shredder tool.

To protect the hands of someone using the shredder tool 2, shield sleeve 40 that covers all or part of the hand of the user. In another embodiment, a shield sleeve 41 extends at least halfway up the lower arm of the user. In one embodiment, the shield sleeve 40 (as well as any alternative embodiments, including but not limited to shield sleeve 41) is made of plastic. In another embodiment, the shield sleeve 40 is made of silicon heat resistant rubber, nylon, any other flexible plastic, cloth or cloth like materials and combinations thereof. In yet another embodiment, the proximal end 22 of the shield sleeve 40 is made of any flexible material attached at the proximal end 22 to a plastic mating structure 23 with the capability of attaching to the rear side of the distal end of the tool support section 21.

The mating or attachment of the shield sleeve 40 to the rear side 6 of the distal end 5 of the tool support section 21 can be accomplished in a number of different ways, most of which are known in the art. The shield sleeve 40 can be attached by compression molding or injection over-molding, injection molded as one homogeneous plastic part, or molded as a soft and stretchable member that is assembled on the rear side 6 of the distal end 5 of the tool support section 21 by stretching it over the tool support section 21 and a lipped edge 42.

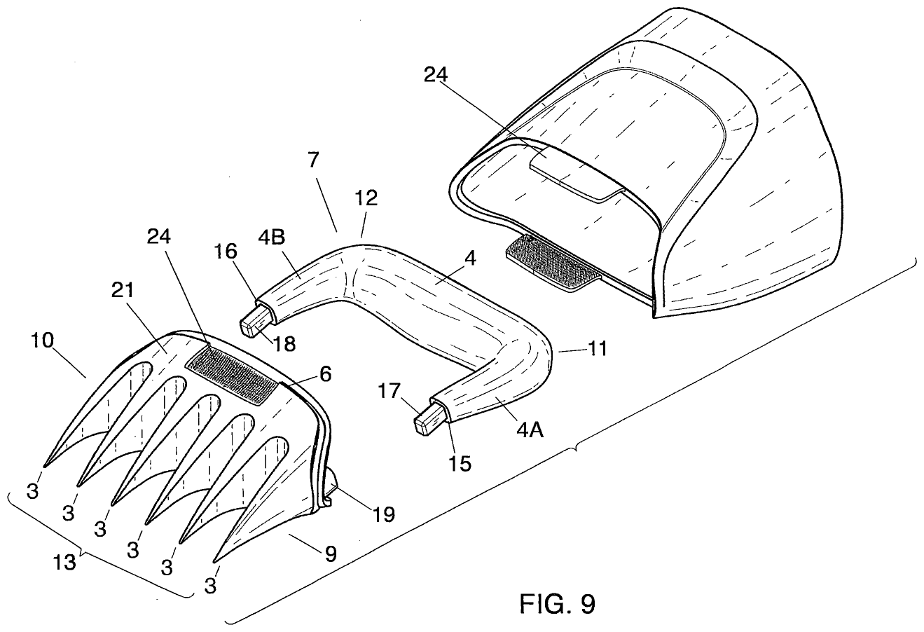

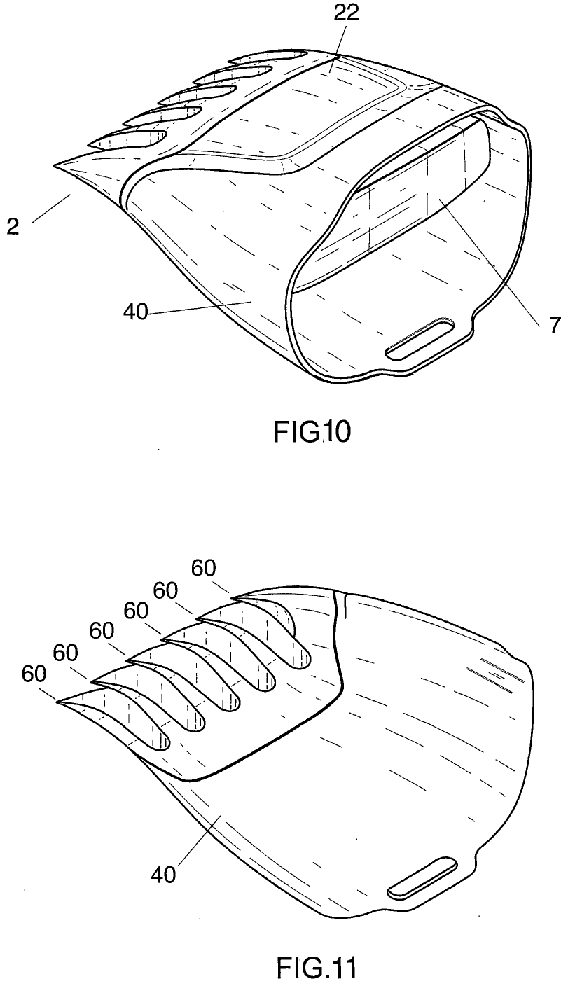

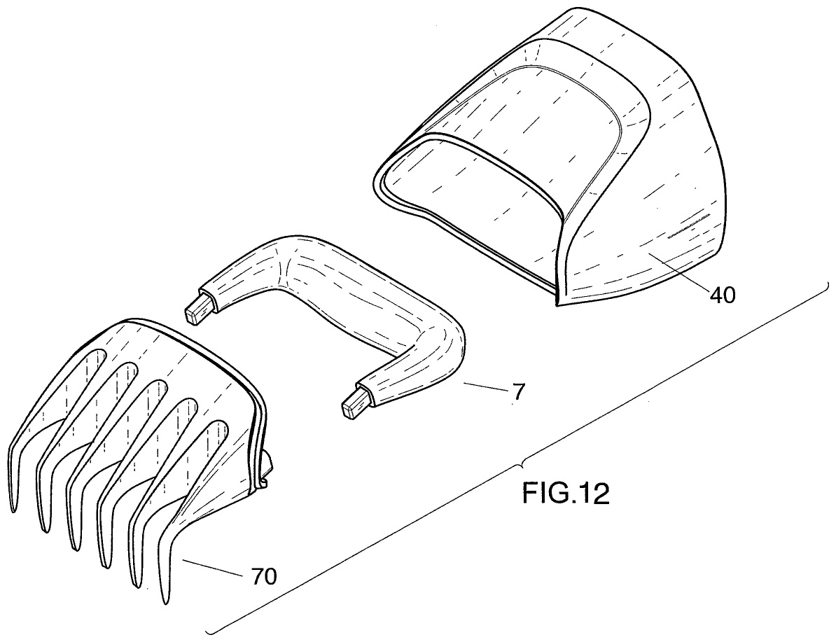

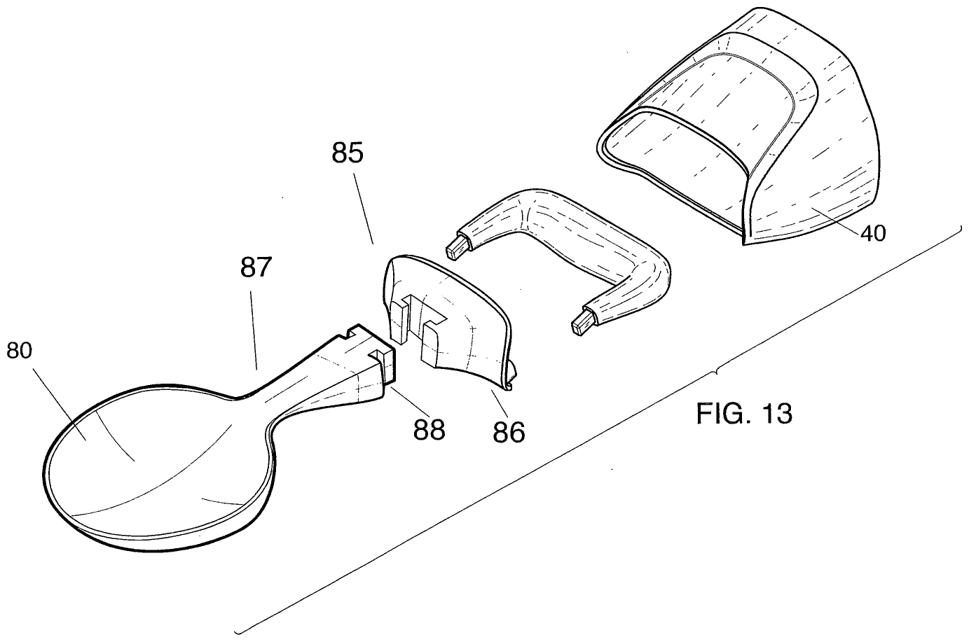

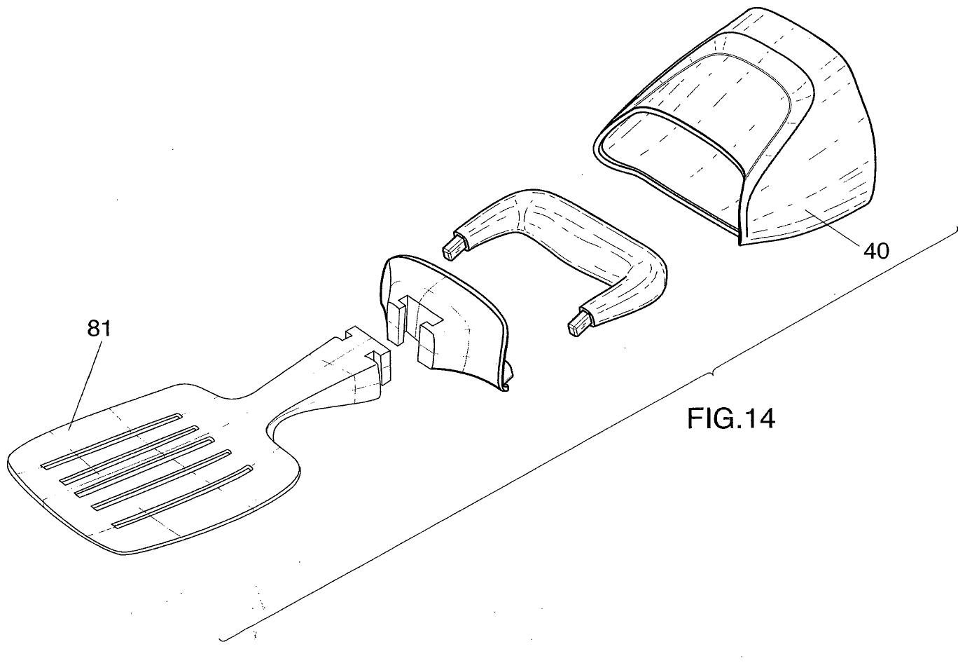

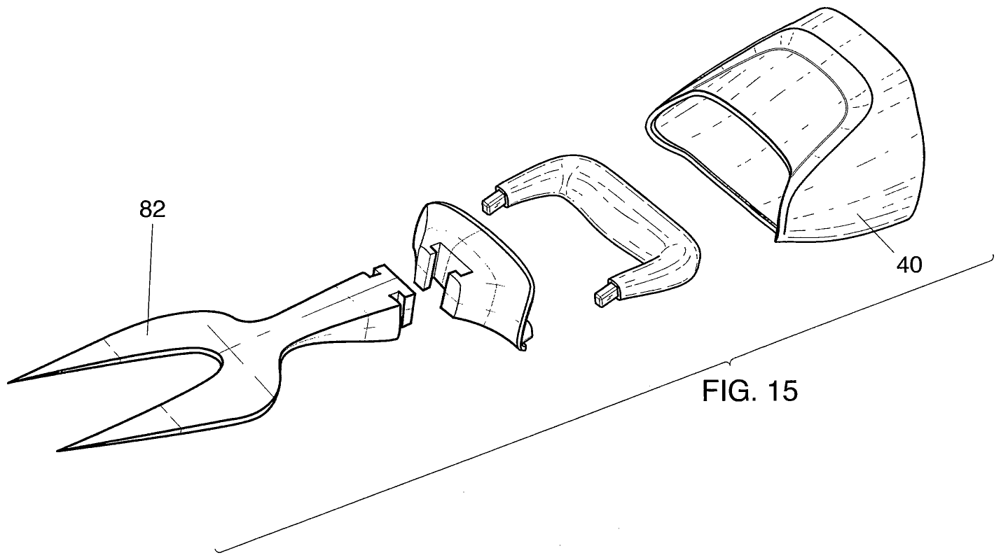

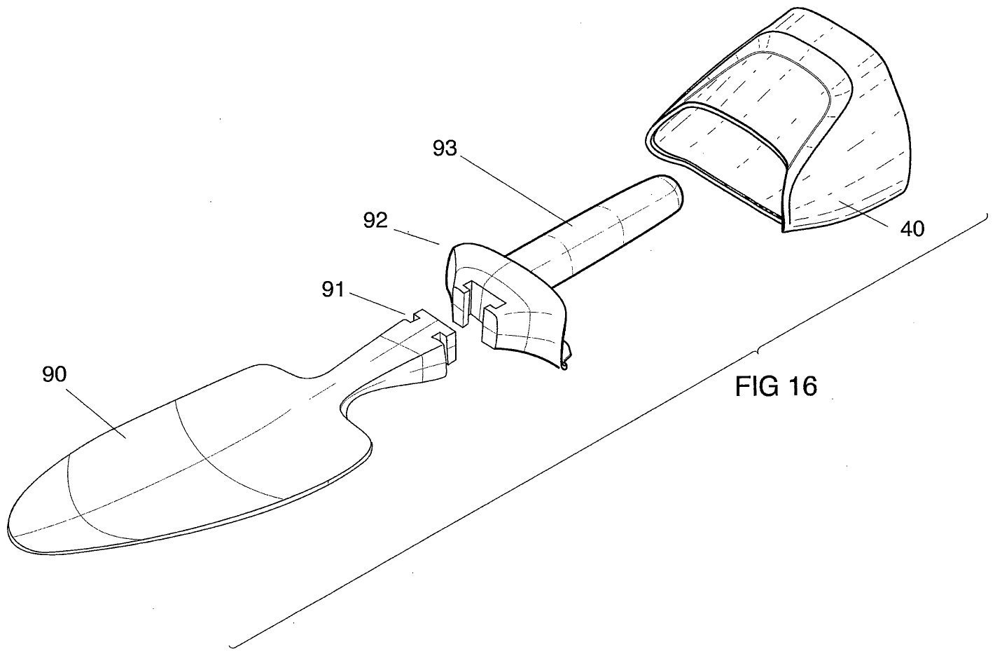

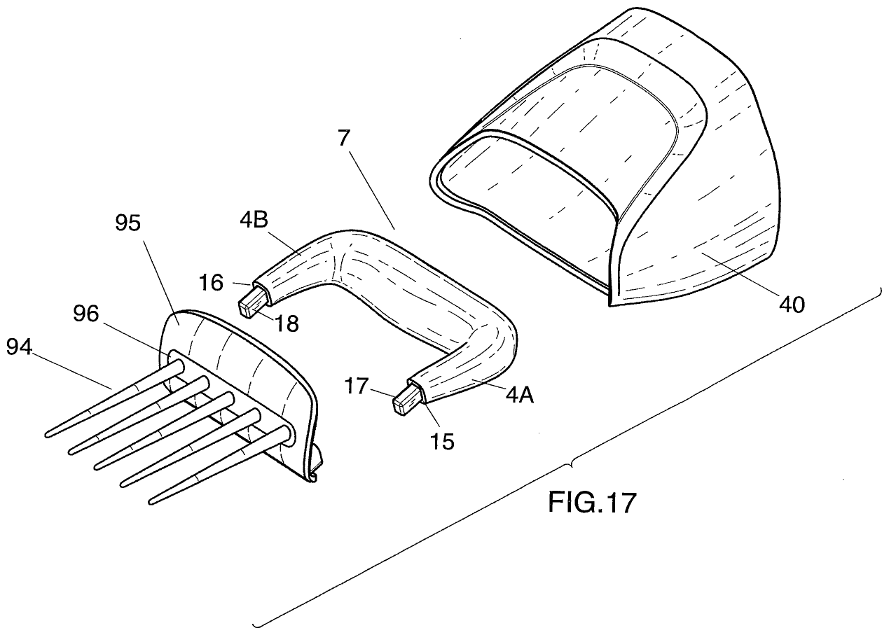

In one embodiment, sleeve 40 fits snugly over the rear side 6 of the distal end 5 of the tool support section 21 or, alternatively, the sleeve 40 fits snugly within the rear side 6 of the distal end 5 of the tool support section 2. In such a case, separation of the shredder attachment 2 and the sleeve 40 is accomplished by manipulating the sides by pressing on them until the two parts separate. In another embodiment the sleeve 40 is reversibly attached to the shredder attachment. Any number of different means can be used, including snaps, buttons (when the shield sleeve is flexible), or countless other means of attachment, including hook and loop strips 24 (FIG. 9).

There are a number of alternative designs for the kitchen tool. In one embodiment, instead of the handle 7 is attached to the shield sleeve 40 instead of being attached to the shredder 2. In this embodiment, tabs 25, 26 are positioned at each end 27, 28 of the handle. These tabs 25, 26 fit through slits 27, 28, each of which is fitted on either side of the sleeve 40, opposite each other. In this embodiment, the part of the sleeve 40 where the slits 27, 28 are positioned are plastic, rubber, or silicon or any material having a degree of rigidity.

In an alternative embodiment, the handle 7 is attached to the tool support section 21 the same way that the handle 7 is attached to the shield sleeve 40. In this embodiment, tabs 25, 26 of handle 7 fit through slits 36, 37 of walls 9, 10. In another embodiment, wherein thandle 7 is vertical to the length of the attachment tool 2, the tabs 25, 26 fit through slits 38, 39 in the top side 34 and the bottom side 35, respectively.

There are a number of alternative embodiments of the disclosure. It should be noted that the shredder attachment can have downwardly pointing tines. In another embodiment, the tines extend outward and then point down,

In alternative embodiments, the shredder attachment can be removed, and replaced with other kitchen tools. For instance, a spoon tool attachment 80 can be used to toss salads or to stir hot soups. In another embodiment an attachable spatula tool attachment 81 can be used, alone or in conjunction with another spatula tool attachment 81 or with a spoon tool attachment 80 In yet another couple of embodiments, a fork tool attachment 82 can be used as well to cut meat or for any other purpose. The tools attachments can be mixed and matched as needed.

In yet another embodiment, the tool can have attachments such that it can be used as a yard tool. As an example, an attachable tool 90 is attached. In one embodiment, the spade tool has at its distal end a male locking attachment piece 91 which can fit into a female tool attachment piece 92 integral with the tool support section 21. In another embodiment, the female and male tool means of linking are reversed. Any method of attachment known in the art can be used to reversibly secure the male locking attachment piece to the female tool attachment piece. Other methods of reversible attachment can be used, other than a male-female attachment, including screws, bolts, etc. in overlapping pieces. In another embodiment, there is a permanent attachment between the handle and the tool, in such cases where there is no interchangeability of the tool. Similarly, and in all cases described supra, the shield sleeve may be used interchangeably and in other cases, the shield sleeve is not interchangeable with other tools.

A handle 93 is attached to the rear of the tool support section by any method described or known in the art. In one embodiment, the handle 93 is positioned along the x axis of tool 1. In another embodiment, the handle is positioned between the two sides of the shield sleeve 40. It should be noted that all of the arrangements of the handle may be used with any of the tools or food implements. Other yard tools that can be attached include a hand trowel, a weeder, transplanter, cultivator and rake.

In FIG. 17, the tool, in this case a plurality of soil breaking tines 94 are connected and attached to a base 96 which in turn is connected to the tool support section 95. Handle 7 is connected to the rear of the tool support section 95, and the hand shield 40 fits over the handle 7 and connects to the tool support section by any means known, including force, glue, the tool support section fitting within grooves, and all other methods discussed supra.

While various embodiments of the present disclosure have been described above, it should be understood that they have been presented by way of example only, and not limitation. It will be apparent to people skilled in the relevant art that various changes in form and detail can be made therein without departing from the spirit and scope of the disclosure. Thus, the breadth and scope of the present disclosure should not be limited by any of the above-described exemplary embodiments but should be defined only in accordance with the following claims and their equivalents.

I claim:

1. A hand tool, comprising:
a) A tool attachment, said tool attachment comprising:
i) a working tool section; and
ii) a tool support section,
said working tool section connected to a proximal end of said tool support section;
b) a shield sleeve, said distal end of said tool support section connected to a proximal end of said shield sleeve; and
c) a handle connected within said tool support section.

2. The hand tool of claim 1, wherein said working tool section is selected from the group consisting of a shredder attachment, a spoon attachment, a fork attachment and a knife attachment.

3. The hand tool of claim 1, wherein said working tool section is a shredder attachment.

4. The hand tool of claim 1, wherein said handle is positioned vertically.

5. The hand tool of claim 1, wherein said handle is positioned horizontally.

6. The hand tool of claim 1, wherein said proximal end of said shield sleeve is reversibly attached to the distal end of said tool support section.

7. The hand tool of claim 1, wherein said distal end of said working tool section is reversibly attached to the proximal end of said tool support section.

8. The hand tool of claim 1, wherein the shield sleeve and the tool support section are integrally molded.

9. A hand tool, comprising:
d) A tool attachment, said tool attachment comprising:
iii) a working tool section; and
iv) a tool support section,
said working tool section connected to a proximal end of said tool support section;
e) a shield sleeve, said distal end of said tool support section connected to a proximal end of said shield sleeve; and
f) a handle connected within said shield sleeve.

10. The hand tool of claim 9, wherein said working tool section is selected from the group consisting of a shredder attachment, a spoon attachment, and a fork attachment.

11. The hand tool of claim 9, wherein said working tool section is a shredder attachment.

12. The hand tool of claim 9, wherein said handle is positioned vertically.

13. The hand tool of claim 9, wherein said handle is positioned horizontally.

14. The hand tool of claim 9 wherein said proximal end of said shield sleeve is reversibly attached to the distal end of said tool support section.

15. The hand tool of claim 9, wherein said distal end of said working tool section is reversibly attached to the proximal end of said tool support section.

16. The hand tool of claim 9, wherein the shield sleeve and the tool support section are integrally molded.

17. A yard tool, comprising:
v) a working tool section; and
vi) a tool support section,
said working tool section connected to a proximal end of said tool support section;
g) a shield sleeve, said distal end of said tool support section connected to a proximal end of said shield sleeve; and
h) a handle connected within said shield sleeve.
